(19) United States
(12) Patent Application Publication
(10) Pub. No.: US 2003/0156840 A1
(43) Pub. Date: Aug. 21, 2003

(54) Wavelength division multiplexing optical transmission apparatus and communication system using the same

(75) Inventor: Tatsuya Uchikata, Tokyo (JP)

Correspondence Address: SUGHRUE MION, PLLC, 2100 Pennsylvania Avenue, Washington, DC, 20037-3213, US

(73) Assignee: NEC CORPORATION

(21) Appl. No.: 10/347,189

(22) Filed: Jan. 21, 2003

(30) Foreign Application Priority Data
Jan. 22, 2002 (JP) 012542/2002

(51) Int. Cl. G02F 1/00

(52) U.S. Cl. 398/7

(57) ABSTRACT

A wavelength division multiplexing optical transmission apparatus and a communication system employing the same are economical and highly reliable. The apparatus includes a plurality of transponders inputting and outputting branched optical signals having respective wavelengths and at least one variable wavelength transponder arranged in parallel to the plurality of transponders. Upon occurrence of failure in any one of the plurality of transponders, the optical signal having wavelength corresponding to the wavelength of the optical signal to be transmitted from the faulty transponder is transmitted from the variable wavelength transponder.

### CROSS REFERENCE TO THE RELATED APPLICATION

The present application has been filed with claiming priority based on Japanese Patent Application No. 2002-012542, filed on Jan. 22, 2002. Disclosure of the above-identified Japanese Patent Application are herein incorporated by reference.

### BACKGROUND OF THE INVENTION

1. Field of the Invention

The present invention relates generally to a wavelength division multiplexing optical transmission apparatus and a communication system using the apparatus. More particularly, the invention relates to a wavelength division multiplexing optical transmission apparatus and a communication system using the apparatus, which are used in wavelength division multiplexing.

2. Description of the Related Art

FIG. 12 is a schematic block diagram showing a construction of one example of a communication system employing the conventional wavelength division multiplexing optical transmission apparatus. Referring to FIG. 12, the conventional communication system is comprising a first terminal station 101 transmitting a wavelength division multiplexed optical signal, an optical demultiplexer 103 receiving the wavelength division multiplexed optical signal through an optical path 102 and demultiplexing the signal to a plurality of mutually different wavelengths λ1, λ2, . . . λN (N is positive integer) of optical signals, transponders 104-1 to 104-N relying respective wavelengths λ1, λ2, . . . λN of optical signals, an optical multiplexer 105 multiplexing respective wavelengths λ1, λ2, . . . λN of optical signals from respective transponders 104-1 to 104-N, and a second terminal station 107 receiving wavelength division multiplexed optical signals output from the optical multiplexer 105 via a transmission path 106.

Such respective transponders 104-1 to 104-N are designed for relying respective wavelengths λ1, λ2, . . . λN of optical signals. It should be noted that the construction comprising the optical demultiplexer 103, the transponders 104-1 to 104-N and the optical multiplexer 105 is referred to as the wavelength division multiplexing optical transmission apparatus in the present invention.

However, in the conventional wavelength division multiplexing optical transmission apparatus, for smooth resumption upon occurrence of failure of the transponders, it is required to establish back-up systems of the number corresponding to number of channels or to reserve spare transponders of the number corresponding to number of channels and number of staff members for quickly taking measure upon occurrence of failure.

FIG. 13 is a schematic block diagram showing one example of a back-up system of the conventional wavelength division multiplexing optical transmission apparatus. In FIG. 13, the same parts as in FIG. 12 are marked the same numbers as in FIG. 12 and those numbers' explanations are omitted. Referring to FIG. 13, the optical signal having wavelength of λ1 is input to the transponder 104-1 via an optical coupler 110-1, reproduced and relied. Then, the optical signal having wavelength λ1 output from the transponder 104-1 is input to the optical multiplexer 105 via an optical coupler 111-1.

On the other hand, for a purpose to cope with failure and the like of the transponder 104-1, a spare transponder 112-1 is connected in parallel to the transponder 104-1. Namely, while the transponder 104-1 is in normal state, the optical signal from the optical demultiplexer 103 is input to the transponder 104-1 via the optical coupler 110-1, and then is input to the optical multiplexer 105 from the transponder 104-1 via the optical coupler 111-1. When failure is caused in the transponder 104-1, the optical signal from the optical demultiplexer 103 is input to the spare transponder 112-1 via the optical coupler 110-1, and is input to the optical multiplexer 105 from the spare transponder 112-1 via the optical coupler 111-1. By this, when failure and the like are caused in the transponder 104-1, it is prevented that transmission of the optical signal interrupts.

Similarly, for other transponders 104-2, . . . 104-N, spare transponders 112-2, . . . 112-N are connected in parallel. Accordingly, interruption of transmission of the optical signal can be prevented, when failure and the like are caused in any of the transponders 104-1, . . . 104-N.

However, increasing of facility and increasing of cost are caused in order to have to provide N spare transponders 112-1 to 112-N.

### SUMMARY OF THE INVENTION

The present invention has been worked out in view of the problems set forth above. It is therefore an object of the present invention to provide a wavelength division multiplexing optical transmission apparatus and a communication system employing the apparatus which is economical and highly reliable.

In order to accomplish the above-mentioned objects, according to one aspect of the present invention, a wavelength division multiplexing optical transmission apparatus for reproduction relaying of a wavelength division multiplexed optical signal, comprises:

a plurality of transponders inputting and outputting branched optical signals having respective wavelengths;

at least one variable wavelength transponder arranged in parallel to the plurality of transponders,

upon occurrence of failure in any one of the plurality of transponders, the optical signal having wavelength corresponding to the wavelength of the optical signal to be transmitted from the faulty transponder being transmitted from the variable wavelength transponder.

In the preferred embodiment, the wavelength division multiplexing optical transmission apparatus may further comprise monitoring control means responsive to occurrence of failure in any one of the transponders, for operating the variable wavelength transponder to output the optical signal having wavelength corresponding to the wavelength of the optical signal to be transmitted from the faulty transponder.

In the alternative, a predetermined number of transponder and the variable wavelength transponder arranged in parallel to the transponders may be combined to form one transponder group, and a plurality of transponder groups may be provided in parallel,

operations of the predetermined number of transponders and the variable wavelength transponder may be monitored per transponder group, and when failure is caused in one of the transponders, the optical signal having wavelength corresponding to the wavelength of the optical signal to be transmitted from the faulty transponder being transmitted from the variable wavelength transponder in the same transponder group with the faulty transponder.

In practical construction, the wavelength division multiplexing optical transmission apparatus may further comprise:

an optical demultiplexing means for demultiplexing the wavelength division multiplexed optical signal into respective wavelengths of optical signals;

a plurality of first optical couplers branching demultiplexed respective wavelengths of optical signals for inputting one of branched optical signals of respective wavelengths to respective of the transponders;

a first optical switch selecting a particular optical signal among the other of the optical signals branched by the plurality of optical couplers for inputting to the variable wavelength transponder;

a second optical switch selecting outputting destination of an output signal from the variable wavelength transponder;

a plurality of second optical couplers coupling the output signals of the respective transponders and the output signal from the second optical switch; and

optical multiplexing means for multiplexing output signals from the plurality of second optical couplers,

when failure is caused in any of the plurality of transponders, the monitoring control means controls the first optical switch, the faulty transponder, the variable wavelength transponder and the second optical switch for transmitting the optical signal having wavelength equal to that of the optical signal to be transmitted from the faulty transponder, from the variable wavelength transponder to the optical multiplexing means.

A plurality of transponders may be constructed with a plurality of first transponders connected input ends to the optical demultiplexing means and output ends to an equipment in a station building, and a plurality of second transponders taking optical signals of respective wavelengths from the equipment in the station building as input signals and outputting to the optical multiplexing means, and the variable wavelength transponder may be arranged in parallel to the plurality of second transponders.

The wavelength division multiplexing optical transmission apparatus may further comprise:

a plurality of optical switches connected between the optical demultiplexing means and the optical multiplexing means per wavelength, a plurality of first transponders providing corresponding to respective optical switches, a plurality of second transponders providing corresponding to respective optical switches, and the variable wavelength transponder,

each of the optical switches has a function for selecting one of the optical signal from the first transponder and the optical signal from the optical demultiplexing means to feed to the optical multiplexing means, and a function for transmitting the optical signal from the optical demultiplexing means to one of the second transponder and the optical multiplexing means, and

the variable wavelength transponder is arranged in parallel to the plurality of first transponders.

The monitoring control means may be responsive to detection of occurrence of failure in any transponder among the plurality of transponders for interrupting optical output of the faulty transponder and subsequently transmitting the optical signal having wavelength equal to that of the optical signal to be transmitted by the faulty transponder from the variable wavelength transponder to the optical multiplexing means.

The wavelength division multiplexing optical transmission apparatus may further comprise a third optical switch provided in place of the first optical coupler, and

when failure is caused in any of the plurality of transponders, the monitoring control means controls the third optical switch, the first optical switch, the faulty transponder, the variable wavelength transponder and the second optical switch for transmitting the optical signal having wavelength equal to that of the optical signal to be transmitted from the faulty transponder, from the variable wavelength transponder to the optical multiplexing means. Alternatively, the wavelength division multiplexing optical transmission apparatus may further comprises a third optical switch provided in place of the first optical coupler, and a third optical coupler provided in place of the first optical switch, and

when failure is caused in any of the plurality of transponders, the monitoring control means controls the third optical switch, the faulty transponder, the variable wavelength transponder and the second optical switch for transmitting the optical signal having wavelength equal to that of the optical signal to be transmitted from the faulty transponder, from the variable wavelength transponder to the optical multiplexing means. In the further alternative, the wavelength division multiplexing optical transmission apparatus may further comprise a fourth optical switch provided in place of the second optical coupler, and

when failure is caused in any of the plurality of transponders, the monitoring control means controls the faulty transponder, the variable wavelength transponder, the second optical switch and the fourth optical switch for transmitting the optical signal having wavelength equal to that of the optical signal to be transmitted from the faulty transponder, from the variable wavelength transponder to the optical multiplexing means.

The optical multiplexing means may include an optical power monitor for monitoring output of the input optical signal, and

when an optical output of the transponder going out of standard is detected as a result of monitoring by the optical power monitor, the monitoring control means transmits the optical signal having wavelength equal to that of the optical signal to be transmitted from the faulty transponder, from the variable wavelength transponder to the optical multiplexing means. Also, an optical transmitter of the transponder may include an optical power monitor for monitoring output of the optical signal to be transmitted, and

when an optical output of the transponder going out of standard is detected as a result of monitoring by the optical power monitor, the monitoring control means transmits the optical signal having wavelength equal to that of the optical signal to be transmitted from the faulty transponder, from the variable wavelength transponder to the optical multiplexing means.

The transponder may include a function of error correction of the optical signal converted into an electric signal.

The transponder may include a signal quality monitoring function of the optical signal converted into an electric signal, and

the monitoring control means is responsive to an alarm indicative a signal quality of the optical signal converted into the electric signal going out of standard, transmits the optical signal having wavelength equal to that of the optical signal to be transmitted from the faulty transponder, from the variable wavelength transponder to the optical multiplexing means.

In the alternative embodiment, a branching ratio of the first optical coupler may be not equal and an optical amplifier is connected between the first optical switch and the variable wavelength transponder in series, and

when failure is caused in any of the plurality of transponders, the monitoring control means controls the first optical switch, the faulty transponder, the variable wavelength transponder and the second optical switch for transmitting the optical signal having wavelength equal to that of the optical signal to be transmitted from the faulty transponder, from the variable wavelength transponder to the optical multiplexing means.

According to the second aspect of the present invention, a communication system including at least one wavelength division multiplexing optical transmission apparatus set forth above between a first terminal and a second terminal terminating the wavelength division multiplexed optical signal.

With the present invention, it becomes possible to provide the wavelength division multiplexing optical transmission apparatus which is economical and highly reliable.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a block diagram showing the first mode of implementation of a wavelength division multiplexing optical transmission apparatus according to the present invention;

FIG. 2 is a block diagram showing an optical multiplexer 8 in the first preferred embodiment of the present invention;

FIG. 3 is a block diagram showing the second mode of implementation of a wavelength division multiplexing optical transmission apparatus according to the present invention;

FIG. 4 is a block diagram showing the second embodiment of a wavelength division multiplexing optical transmission apparatus according to the present invention;

FIG. 5 is a block diagram showing the third embodiment of a wavelength division multiplexing optical transmission apparatus according to the present invention;

FIG. 6 is a block diagram showing the fourth embodiment of a wavelength division multiplexing optical transmission apparatus according to the present invention;

FIG. 7 is a block diagram showing the fifth embodiment of a wavelength division multiplexing optical transmission apparatus according to the present invention;

FIG. 8 is a block diagram showing the sixth embodiment of a wavelength division multiplexing optical transmission apparatus according to the present invention;

FIG. 9 is a block diagram showing the seventh embodiment of a wavelength division multiplexing optical transmission apparatus according to the present invention;

FIG. 10 is a block diagram showing the eighth embodiment of a wavelength division multiplexing optical transmission apparatus according to the present invention;

FIG. 11 is a block diagram showing the ninth embodiment of a wavelength division multiplexing optical transmission apparatus according to the present invention;

FIG. 12 is a block diagram showing one example of the conventional communication system employing the wavelength division multiplexing optical transmission apparatus; and

FIG. 13 is a block diagram showing one example of a back-up system of the conventional wavelength division multiplexing optical transmission apparatus.

### DESCRIPTION OF THE PREFERRED EMBODIMENT

The present invention will be discussed hereinafter in detail in terms of the preferred embodiments of a wavelength division multiplexing optical transmission apparatus and a communication system employing the same of the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessary obscurity of the present invention.

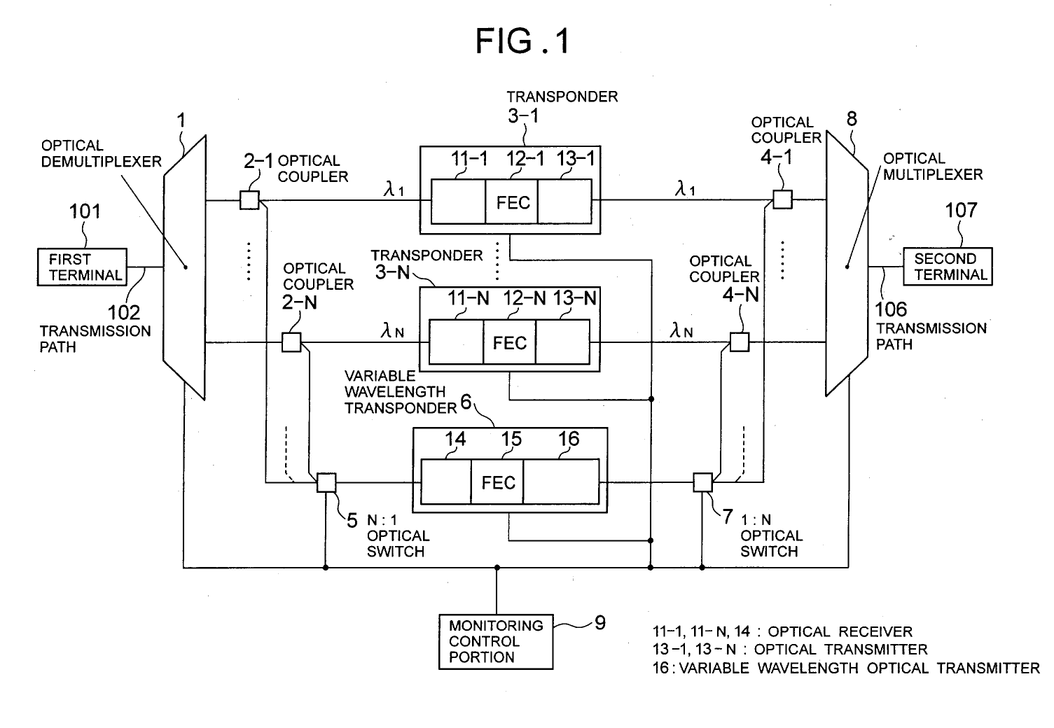

At first, discussion will be given for the first mode of implementation of the present invention. FIG. 1 is a block diagram showing the first mode of implementation of a wavelength division multiplexing optical transmission apparatus according to the present invention. Referring to FIG. 1, a wavelength division multiplexing optical transmission apparatus according to the present invention includes an optical demultiplexer 1 branching N in number of wavelengths λ1 to λN of wavelength division multiplexed optical signals, an optical coupler 2-1 branching the optical signal having wavelength of λ1 into two, a transponder 3-1 to be input one of branched optical signals from the optical coupler 2-1, an optical coupler 4-1 coupling the optical signal having the wavelength λ1 from the transponder 3-1 with other optical signal, an optical signal 2-N branching the optical signal having the wavelength of λN into two, a transponder 3-N to be input one of branched optical signals from the optical coupler 2-N, an optical coupler 4-N coupling the optical signal having the wavelength λN output from the transponder 3-N with other optical signal, an N:1 optical switch 5 input the other of branched signals from respective optical couplers N-1 to 2-N and selecting the optical signal of one of wavelength λM (M is positive integer) among these input branched signals. On the other hand, the wavelength division multiplexing optical transmission apparatus also includes a variable wavelength transponder 6 input the optical signal selected by the N:1 optical switch 5, an 1:N optical switch 7 selectively inputting the optical signal output from the variable wavelength transponder 6 to corresponding one of the optical couplers 4-1 to 4-N, an optical multiplexer 8 for wavelength division multiplexing by multiplexing N in number of respective optical signals, a monitoring control portion 9 controlling the optical demultiplexer 1, the transponders 3-1 to 3-N, the N:1 optical switch 5, the variable wavelength transponder 6, 1:N optical switch 7 and the optical multiplexer 9.

On the other hand, the transponder 3-1 is constructed with an optical receiver 11-1 converting the optical signal from the optical coupler 2-1 into an electric signal, an FEC (Forward Error Correction) portion 12-1 having an error correction function of the electric signal and a function for adding an error correction bit, and an optical transmitter 13-1 converting the electric signal into an optical signal having wavelength of λ1. Similarly, the transponder 3-N is constructed with an optical receiver 11-N converting the optical signal from the optical coupler 2-N into an electric signal, an FEC portion 12-N having an error correction function of the electric signal, and an optical transmitter 13-N converting the electric signal into an optical signal having wavelength of λN. Furthermore, the variable wavelength transponder 6 is constructed with an optical receiver 14 converting the optical signal selected by the N:1 optical switch 5 into an electric signal, an FEC portion 15 having an error correcting function for the electric signal and a variable wavelength optical transponder 16 converting the electric signal into an optical signal having one wavelength λM.

It should be noted that a communication system using the wavelength division multiplexing optical transmission apparatus may be constructed by connecting the optical demultiplexer 1 and a first terminal station 101 via a transmission path 102 and by connecting the optical multiplexer 8 and the second terminal 107 via a transmission path 106.

Next, referring to FIG. 1, operation in the first mode of implementation of the present invention will be discussed in detail. The optical signal wavelength division multiplexed and transmitted to the transmission path 102 which is constructed with one optical fiber is branched into respective wavelengths λ1 to λN by the optical demultiplexer 1. The optical signal having wavelength λ1 is branched by the optical coupler 2-1 for inputting one branched optical signal to the optical receiver 11-1, in which the branched optical signal is converted into the electric signal. The FEC portion 12-1 in the later stage performs error correction (decoding) on the basis of code error correction bit in the electric signal and adds the code error correction bit (encoding) to the electric signal after error correction.

Subsequently, the electric signal is converted into the optical signal having wavelength λ1 by the optical transmitter 13-1 and then input to the optical multiplexer 8 through the optical coupler 4-1. On the other hand, for the optical signals having wavelengths λ2 to λN, similar processes are performed for inputting N in number of optical signals to the optical multiplexer 8 to be multiplexed therein and then output to a transmission path 106. This is referred to as an optical reproduction relay (3R (Reshaping, Retiming and Regenerating) relay) and is inherent for very long range optical transmission.

On the other hand, N in number of optical signals branched by the optical couplers 2-1 to 2-N are input to the N:1 optical switch 5. When the optical reproduction relay is in operation normally, the N:1 optical switch 5 outputs the optical signal having arbitrary wavelength. The variable wavelength transponder 6 connected to the N:1 optical switch 5 receives the optical signal having arbitrary wavelength output from the optical switch 5. However, the variable wavelength optical transponder 16 is maintained in optical output (shut-down) state by the control signal from the monitoring control portion 9.

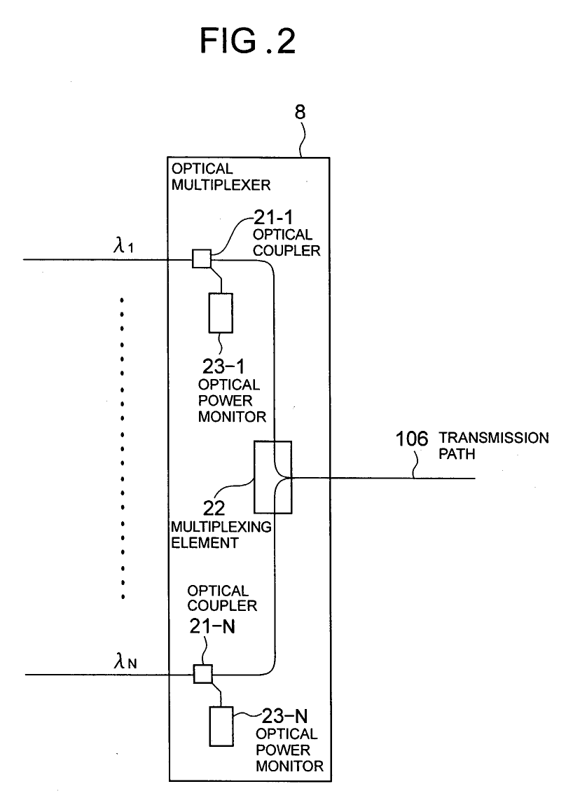

As one example, discussion will be given for the case where failure is caused in the transponder 3-1, thus the optical transmitter 13-1 fails to output the optical signal and the optical multiplexer 8 detects failure. Here, discussion will be given for the construction of the optical multiplexer 8. FIG. 2 shows the optical multiplexer 8 to be employed in the first embodiment. Referring to FIG. 2, the optical multiplexer 8 is constructed with optical couplers 21-1 to 21-N branching the optical signal having respective wavelengths λ1 to λN, a multiplexer element 22 multiplexing one of branched optical signals, and optical power monitors 23-1 to 23-N monitoring the other of branched optical signal outputs. Namely, the optical multiplexer 8 has optical power monitoring function to be achieved by the optical power monitors 23-1 to 23-N.

At a timing where alarm is issued to the monitoring control portion 9 from the optical multiplexer 8 through a not shown communication function in the optical multiplexer 8, the N:1 optical switch 5 selects and outputs the light having wavelength λ1. The optical receiver 14 of the variable wavelength transponder 6 converts the optical signal having wavelength λ1 into the electric signal. Then, error correction is effected and code error correction bit is added by the FEC portion 15. Thereafter, the electric signal is converted into the optical signal having wavelength λ1 by the variable wavelength optical transponder 16 to perform optical output (release shut-down).

The variable wavelength optical transponder 16 may output the lights having wavelengths λ1 to λN. In the shown case, the wavelength of the faulty transponder 3-1, namely wavelength λ1 is output. The 1:N optical switch 7 outputs the optical signal of the variable wavelength optical transponder 16 to the optical coupler 4-1. The optical signal reaches the optical multiplexer 8 through the optical coupler 4-1. It should be noted that a series of switching operation is performed according to instruction of the monitoring control portion 9.

Such variable wavelength transponder 6 may automatically operate as faulty channel upon occurrence of failure in one channel of the transponders 3-1 to 3-N as replacement.

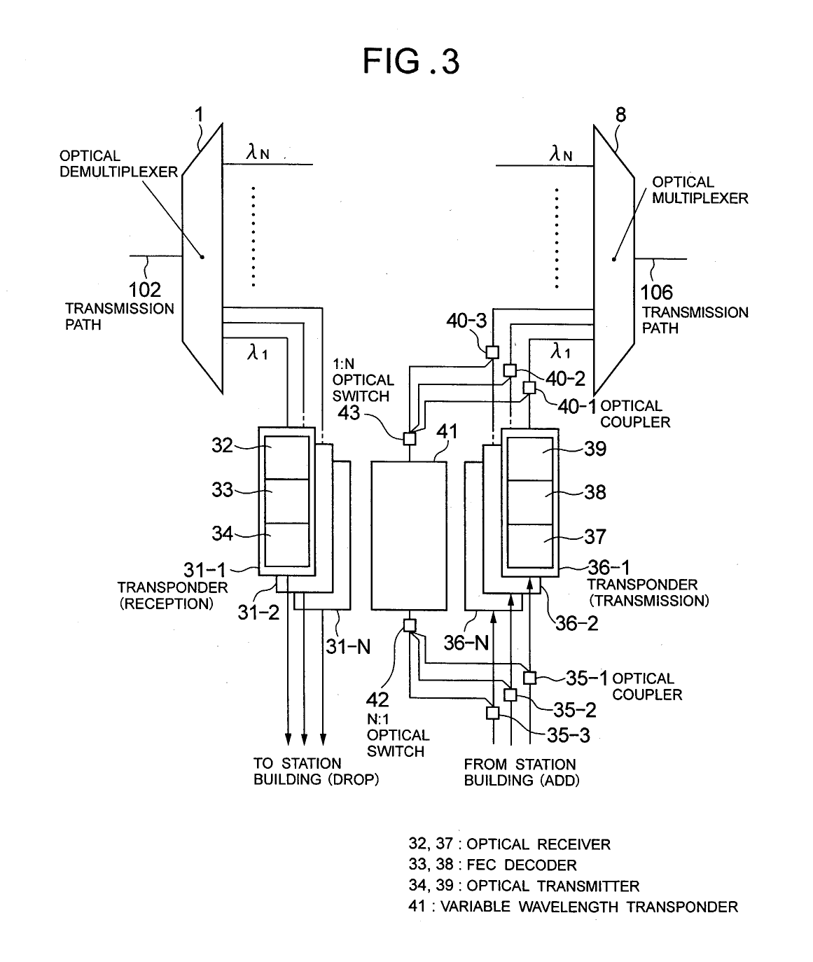

Next, discussion will be given for the second mode of implementation of the wavelength division multiplexing optical transmission apparatus and the communication system employing the same in accordance with the present invention. FIG. 3 is a block diagram showing a construction of the second mode of implementation of the present invention. It should be noted that like components in the shown embodiment common to the former embodiment will be identified by like reference numerals and detailed description of such common components will be eliminated for avoiding redundant disclosure and whereby to keep the disclosure simple enough to facilitate clear understanding of the present invention. In the first mode of implementation, the transponders 3-1 to 3-N simply operate for relaying optical signals. In contrast to this, in the second mode of implementation of the present invention, two series of transponders are provided. One of two series of transponders are provided on input (reception) side for inputting optical signals of respective wavelengths λ1 to λN from the optical demultiplexer 1 to not shown a station building, and the other series of transponders are provided on output (transmission) side for outputting the optical signals having respective wavelengths λ1 to λN from the station building to the optical multiplexer 8. In further particular discussion, on the input side of the optical signal, a process (drop) for branching a predetermined wavelength of optical signal is performed, and on the output side of the optical signal, a process (add) for inserting the predetermined wavelength of the optical signal is performed. The transponders employed in the second mode of implementation of the present invention are those to be employed in the wavelength division multiplexing optical transmission apparatus having add-drop function.

Referring to FIG. 3, the wavelength division multiplexed optical signal transmitted over a long distance through the transmission path 102 is branched into respective wavelengths of λ1 to λN by the optical demultiplexer 1. The optical signal having wavelength λ1 is input to the optical receiver 32 in the reception side transponder 31-1 and converted into the electric signal therein. The FEC decoder 3 in the later stage performs error correction on the basis of the code error correction code in the electric signal (decoding). Subsequently, the electric signal is converted into the optical signal by the optical transmitter 34 and then transmitted within the station building to perform process for branching the optical signal (drop). For the optical signals having respective wavelengths λ2 to λN, similar process is performed.

On the other hand, the optical signal having wavelength λ1 provided the process (add) to insert the optical signal in the station building, is branched by the optical coupler 35-1. One of the branched optical signal is input to the optical receiver 37 in the transmission side transponder 36-1. Then, the branched optical signal is converted into the electric signal, added the code error correction bit in the FEC decoder 38, converted into the optical signal having wavelength λ1 by the optical transmitter 39, and then input to the optical multiplexer 8 through the optical coupler 40-1. Then, the optical signal having respective wavelengths λ1 to λN is multiplexed by the optical multiplexer 8 and output to the transmission path 106.

On the other hand, in parallel to the transmission side transponders 36-1 to 36-N, a variable wavelength transponder 41, N:1 optical switch 42 and 1:N optical switch 43 similar to the first mode of implementation are connected.

Here, it is assumed that the optical multiplexer 8 detects that failure is caused in the transmission side transponder 36-1 outputting the optical signal having wavelength λ1, and the optical transmitter 39 fails to output the optical signal. In such case, at a timing where alarm is issued by the optical multiplexer 8, the N:1 optical switch 42 selects the optical signal output from the optical coupler 35-1 to output to the variable wavelength transponder 41. In the variable wavelength transponder 41, the optical signal is converted into the electric signal. Then, code error correction bit is added, and thereafter, the electric signal is converted into the optical signal to output the optical signal having wavelength λ1. The variable wavelength transponder 41 may output the optical signal having wavelengths λ1 to λN. In the shown case, the wavelength of the faulty transponder, namely wavelength λ1 is output. The 1:N optical switch 43 outputs the optical signal of the variable wavelength transponder 41 only to the optical coupler 40-1. The optical signal reaches the optical multiplexer 8 through the optical coupler 40-1 to be subject to wavelength division multiplexing and then output to the transmission path 106.

A series of switching operation is performed under instruction of the not shown monitoring control portion 9 similarly to the first mode of implementation. Such variable wavelength transponder 41 may automatically operate as faulty channel upon occurrence of failure in one channel of the transponders 36-1 to 36-N as replacement.

[Embodiment]

Next, discussion will be given for the embodiments of first mode of implementation of the present invention. At first, discussion will be given for the first embodiment. In the first embodiment, a failure different from the failure discussed in the first mode of implementation set forth above is assumed. When error correction cannot be performed completely by the FEC portion 12-1 of the transponder 3-1 due to occurrence of failure in the receiving portion of the transponder 3-1 or other cause, quality of the reception signal goes output of standard value. Then, alarm is transferred to the monitoring control portion 9 through the transponder 3-1. At this time, the monitoring control portion 9 outputs instruction for stopping optical output of the optical transmitter 13-1 to the transponder 3-1. After confirming that the optical output is really stopped by the optical power monitor 23-1 of the optical multiplexer 8, a series of switching operation starting from selection of the optical signal having wavelength λ1 of the N:1 optical switch 5, is initiated. By this, the optical signal having wavelength λ1 from the variable wavelength transponder 6 is input to the optical multiplexer 8 via the 1:N optical switch 7 and the optical coupler 4-1.

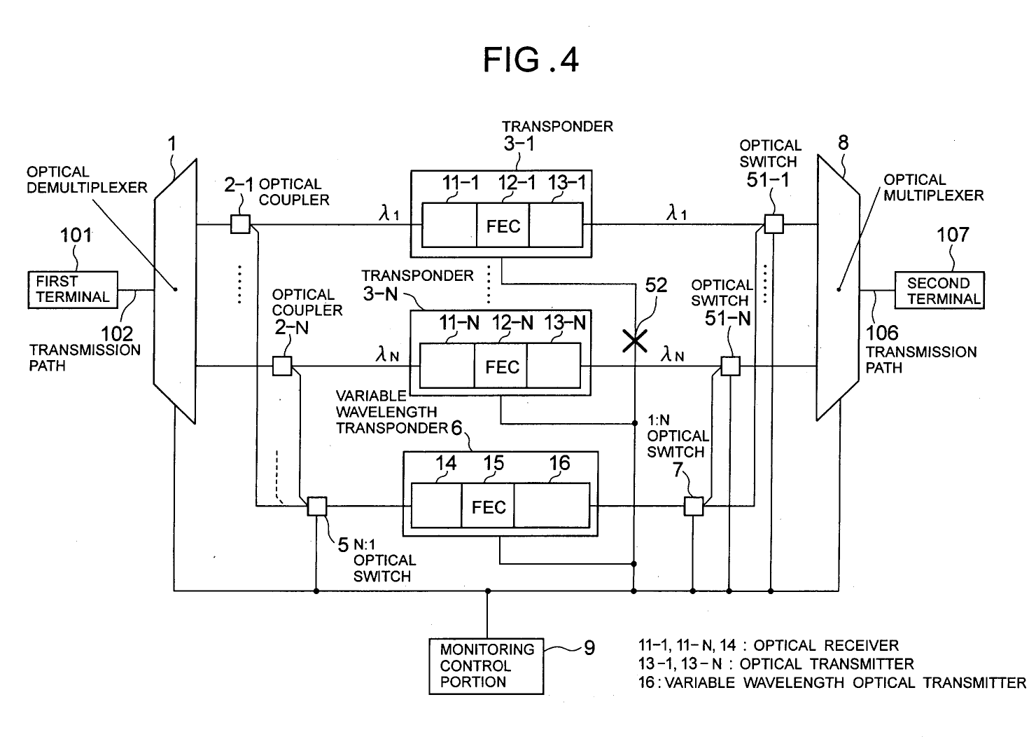

Next, discussion will be given for the second embodiment. FIG. 4 is a block diagram showing the construction of the second embodiment. It should be noted that like components in the shown embodiment to those in FIG. 1 will be identified by like reference numerals and detailed description of such common components will be eliminated for avoiding redundant disclosure and whereby to keep the disclosure simple enough to facilitate clear understanding of the present invention. Different point of FIG. 4 to FIG. 1 is that the optical couplers 4-1 to 4-N of FIG. 1 are replaced with optical switches 51-1 to 51-N, and these optical switches 51-1 to 51-N are also controlled by the monitoring control portion 9.

As one example of the second embodiment, a case where communication failure is caused between the transponder 3-1 and the monitoring control portion 9, is considered (point 52 in FIG. 4 (shown by x)). In such case, even when failure is caused in certain failure in the transponder 3-1, alarm cannot be transferred to the monitoring control portion 9 from the transponder 3-1 since communication between the transponder 3-1 and the monitoring control portion 9 is failed. In such case, the monitoring control portion 9 performs the following operation.

At first, an inquiry signal inquiring failure condition is transmitted to the transponder 3-1 from the monitoring control portion 9 through the communication line. This may be transmitted as required or transmitted regularly. However, for communication failure between the transponder 3-1 and the monitoring control portion 9, correct response should not be returned from the transponder 3-1. Therefore, when response from the transponder 3-1 cannot be received within a given period after transmission of the inquiry signal, the monitoring control portion 9 regards that failure is caused in the transponder 3-1. Then, N:1 optical switch 5 selects the light having wavelength λ1 to output to the variable wavelength transponder 6. The optical switch 51-1 is switched from the optical transmitter 3-1 side to the 1:N optical switch 7 side. By this, transmission of the optical signal from the optical transmitter 13-1 of the transponder 3-1 is shut off, and in replace, the optical signal having wave length λ1 from the variable wavelength optical transmitter 16 of the variable wavelength transponder 6 is input to the optical multiplexer 8 via the 1:N optical switch 7 and the optical switch 51-1.

Next, discussion will be given for the third embodiment. In the first mode of implementation, back-up for all of N in number of transponders 3-1 to 3-N is performed by one variable wavelength transponder 6. In practice, in consideration of failure rate of the transponder and reliability and cost of the necessary system, an optimal value of the transponder for effecting back-up with one variable wavelength transponder can be determined.

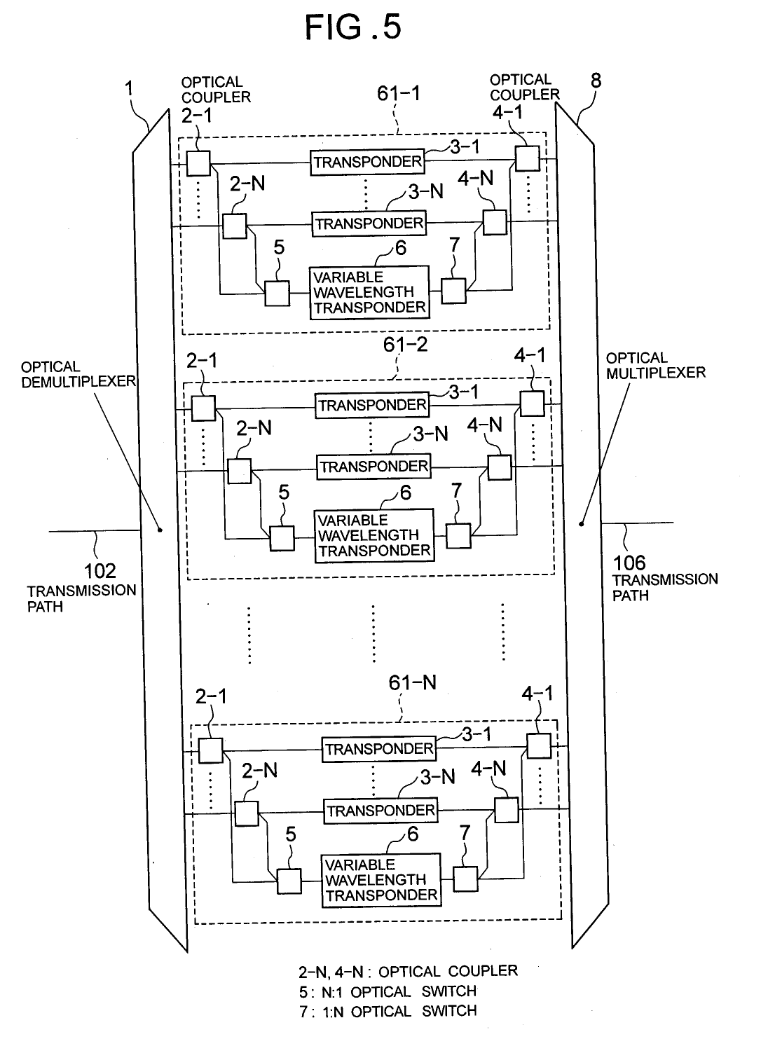

In the present invention, the optical signals having different wavelengths of 1 to 160 channels are transmitted by one optical fiber is considered as one example. Accordingly, one to one hundred sixty transponders become necessary. However, it is difficult to back-up large number of transponders with one variable wavelength transponder. Therefore, a construction shown in FIG. 5 is considered. FIG. 5 is a block diagram showing the third embodiment of the present invention. It should be noted that like components in the shown embodiment common to FIG. 1 will be identified by like reference numerals and detailed description of such common components will be eliminated for avoiding redundant disclosure and whereby to keep the disclosure simple enough to facilitate clear understanding of the present invention.

FIG. 5 shows the embodiment, in which one variable wavelength transponder 6 is provided for twenty (N=20) transponders 3-1 to 3-N and a set of one variable length transponder 6 and twenty transponders 3-1 to 3-N is taken as one transponder group 61. The transponder groups 61 are provided in number corresponding to total number of transponders. For instance, when the total number of transponders is forty, two transponder groups 61 are provided. Likewise, when the total number of transponders is one hundred sixty, eight transponder groups 61 are provided. It should be noted that while not illustrated in FIG. 5, the transponders 3-1 to 3-N, the variable wavelength transponder 6, the optical switches 5, 7, the optical demultiplexers 1 and optical multiplexer 8 are controlled by the monitoring control portion 9 similarly to FIG. 1.

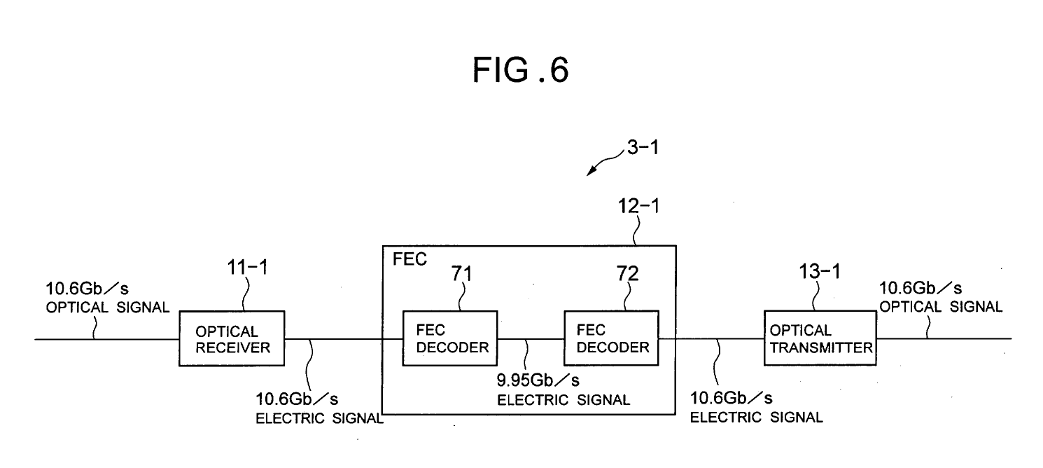

Next, discussion will be given for the fourth embodiment. FIG. 6 is a block diagram showing the fourth embodiment. FIG. 6 shows one example of the construction of the transponder in the fourth embodiment. It should be noted that like components in the shown embodiment common to FIG. 1 will be identified by like reference numerals and detailed description of such common components will be eliminated for avoiding redundant disclosure and whereby to keep the disclosure simple enough to facilitate clear understanding of the present invention. In FIG. 6, as one example, there is shown a construction of the transponder 3-1. However, transponders 3-2 to 3-N have similar construction.

Referring to FIG. 6, the transponder 3-1 is constructed with an optical receiver 11-1 having a function of receiving the optical signal and converting the received optical signal into the electric signal, the FEC 12-1 including an FEC decoder 71 performing error correction using the error correction bit in the electric signal and an FEC decoder 72 inserting the error correction bit to the signal, and the optical transmitter 13-1 having function converting the electric signal into the optical signal.

More particularly, the optical signal having wavelength λ1 and transmission rate 10.6 Gb/s, as one of wave in wavelength division multiplexed optical signal, is input to the optical receiver 11-1. The optical signal is converted into the electric signal having frequency of 10.6 Gb/s for outputting. Next, the electric signal having frequency of 10 Gb/s is input to the FEC decoder 71 to subject error correction using the error correction bit in 10 Gb/s data. After error correction, the electric signal output from the FEC decoder 71 becomes 9.95 Gb/s. Next, the electric signal having transmission rate 9.95 Gb/s is input to the FEC decoder 72 and the error correction bit is inserted in the electric signal. Therefore, a frequency of the electric signal output from the FEC decoder 72 is original 10 Gb/s. Then, the electric signal of 10 Gb/s is converted into the optical signal of 10 Gb/s by the optical transmitter 13-1.

It should be noted that the error correcting function as the FEC portion 12-1 is not necessarily inherent. If separate quality monitoring function of the signal is available, it may be replacement of the error correcting function of the FEC portion 12-1.

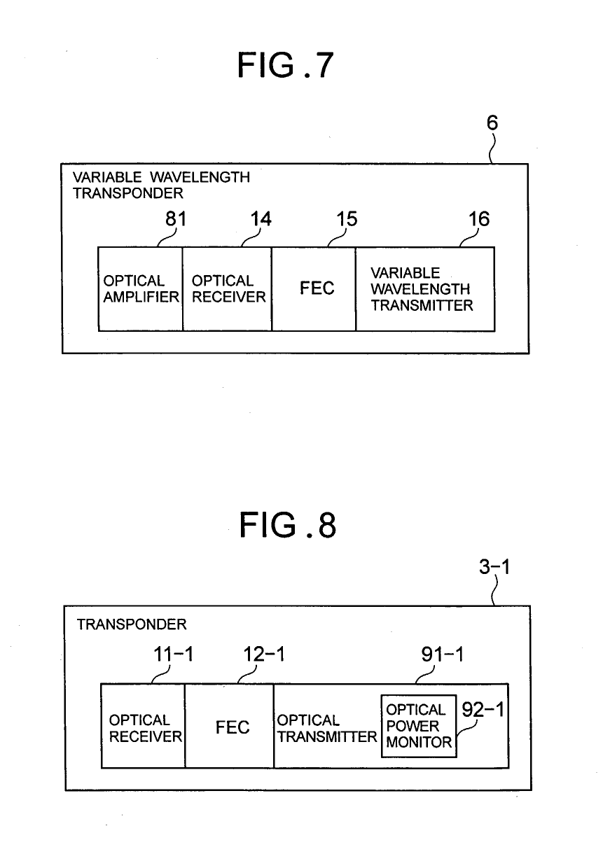

Next, discussion will be given for the fifth embodiment of the present invention. FIG. 7 is a block diagram showing the construction of the fifth embodiment. It should be noted that like components in the shown embodiment common to FIG. 1 will be identified by like reference numerals and detailed description of such common components will be eliminated for avoiding redundant disclosure and whereby to keep the disclosure simple enough to facilitate clear understanding of the present invention. Referring to FIG. 1, in the first mode of implementation of the invention, the optical coupler 2-1 equally divides the input optical signal for inputting to the optical receiver 11-1 of the transponder 3-1 and the optical receiver 14 of the variable wavelength transponder 6. Accordingly, by establishing a back-up system with the variable wavelength transponder 6, it becomes necessary to input double power of optical signal to the optical coupler 2-1 as compared with the case where the back-up system is not provided. This serves as constraint in designing the transmission path.

Therefore, as shown in FIG. 7, in the fifth embodiment, an optical amplifier 81 is inserted upstream side of the optical receiver 14 of the variable wavelength transponder 6. In this case, the optical coupler 2-1 can be regarded that variation of the optical power input to the optical coupler 2-1 is a little relative to the optical power input to the optical receiver 11-1 by branching the light at 10:1 relative to the optical receiver 11-1 and the optical receiver 14, for example. Also, by setting an amplification of the optical amplifier 81 to ten times, the comparable optical power can be input even for the optical receiver 14.

Next, discussion will be given for the sixth embodiment of the present invention. FIG. 8 is a block diagram showing the sixth embodiment. It should be noted that like components in the shown embodiment common to FIG. 1 will be identified by like reference numerals and detailed description of such common components will be eliminated for avoiding redundant disclosure and whereby to keep the disclosure simple enough to facilitate clear understanding of the present invention. In the sixth embodiment, the optical transmitters 13-1 to 13-N in the transponders 3-l to 3-N are modified. It should be noted that while construction of the transponder 3-1 is illustrated in FIG. 8 as one example, the transponders 3-2 to 3-N may have similar construction.

Referring to FIG. 8, an optical power monitor 92-1 for monitoring the output of the optical signal to be transmitted is provided in the optical transmitter 91-1 of the transponder 3-1. Now, when the power monitored by the optical power monitor 92-1 becomes lower than or equal to a given threshold value, the monitoring control portion 9 recognizes occurrence of abnormality in the optical transmitter 91-1 of the transponder 3-1 and performs control for stopping the output of the optical transmitter 91-1. When the optical power monitor 23-1 of the optical multiplexer 8 confirms interruption of the optical signal having wavelength λ1, the monitoring control portion 9 makes the N:1 optical switch 5 to select the optical signal having wavelength λ1. The selected optical signal of wavelength λ1 is input to the optical multiplexer 8 through the variable wavelength transponder 6, the 1:N optical switch 7 and the optical coupler 4-1.

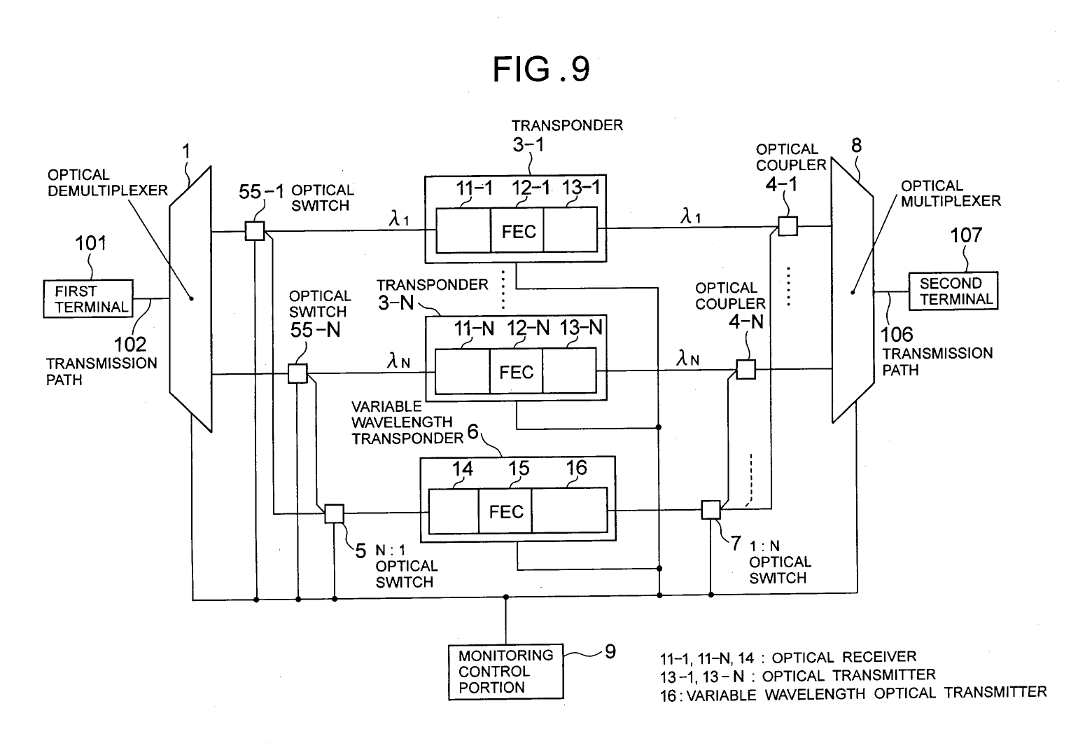

Next, discussion will be given for the seventh embodiment of the present invention. The seventh embodiment is a modification of the first embodiment illustrated in FIG. 1. FIG. 9 is a block diagram showing the seventh embodiment. It should be noted that like components in the shown embodiment common to FIG. 1 will be identified by like reference numerals and detailed description of such common components will be eliminated for avoiding redundant disclosure and whereby to keep the disclosure simple enough to facilitate clear understanding of the present invention. The seventh embodiment is differentiated from the first embodiment in that the optical couplers 2-1 to 2-N in the first embodiment are replaced with optical switches 55-l to 55-N, and the monitoring control portion 9 newly controls the optical switches 55-1 to 55-N. Otherparts of the construction are similar or common to the first embodiment.

Namely, upon occurrence of failure in any one of the transponders 3-1 to 3-N, the monitoring control portion 9 controls the optical demultiplexer 1, the optical switches 55-1 to 55-N, N:1 optical switch 5, the transponders 3-1 to 3-N, the variable wavelength transponder 6, 1:N optical switch 7 and the optical multiplexer 8 so that the optical signal having equal wavelength as the optical signal to be output from the faulty transponder 3 is output from the variable wavelength transponder 6 to the optical multiplexer 8.

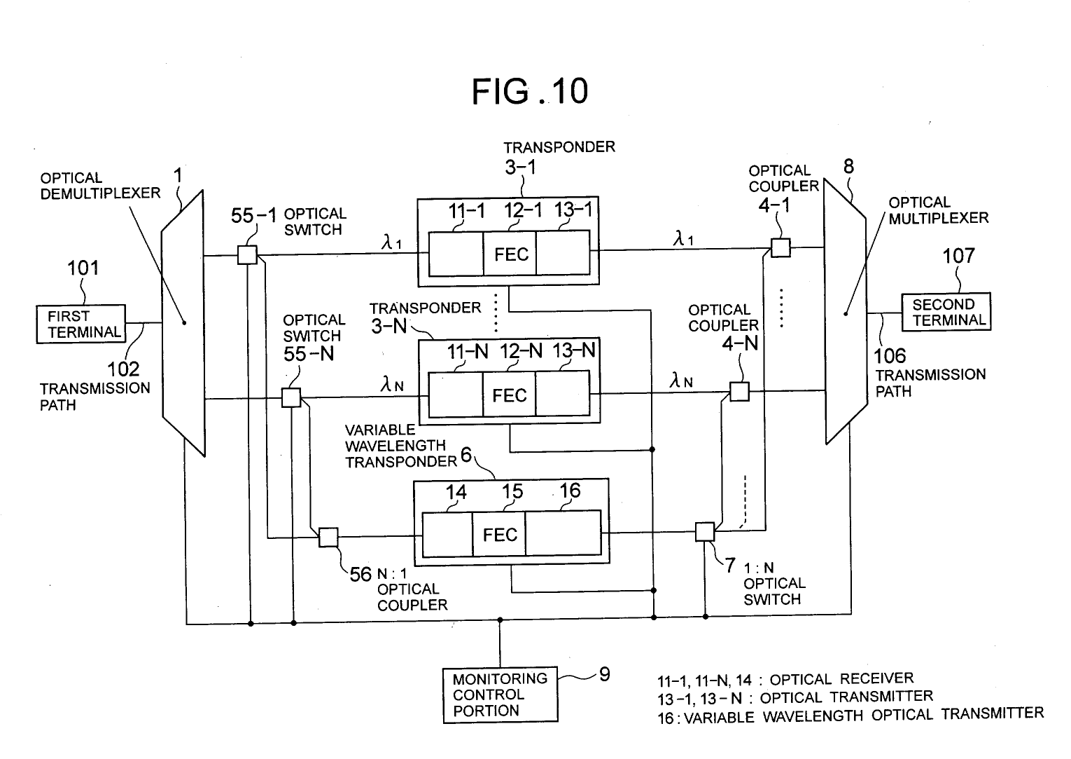

Next, the eighth embodiment will be discussed. The eighth embodiment is another modification of the first mode of implementation of the present invention (see FIG. 1). FIG. 10 is a block diagram showing a construction of the eighth embodiment. It should be noted that like components in the shown embodiment common to FIG. 1 will be identified by like reference numerals and detailed description of such common components will be eliminated for avoiding redundant disclosure and whereby to keep the disclosure simple enough to facilitate clear understanding of the present invention. The eighth embodiment is differentiated from the first embodiment illustrated in FIG. 1 in that the optical couplers 2-1 to 2-N in the first embodiment is replaced with the optical switches 55-1 to 55-N, the N:1 optical switch 5 in the first embodiment is replaced with an N:1 optical coupler 56, and the monitoring control portion 9 newly controls the optical switches 55-1 to 55-N. Other parts of the construction are similar or common to the first embodiment.

Namely, when failure is caused in any one of the transponders 3-1 to 3-N, the monitoring control portion 9 controls the optical demultiplexer 1, the optical switches 55-1 to 55-N, the transponders 3-1 to 3-N, the variable wavelength transponder 6, the 1:N optical switch 7 and the optical multiplexer 8 for feeding the optical signal having the wavelength equal to that of the optical signal to be output from the faulty transponder 3, to the optical multiplexer 8 from the variable wavelength transponder 6.

It should be noted that the wavelength division multiplexing optical transmission apparatus in the second mode of implementation of the present invention (see FIG. 3) is differentiated from the first mode of implementation of the invention (see FIG. 1) in that the variable wavelength transponder 41 is provided for the transponders 36-1 to 36-N on transmission side (add side). However, the second mode of implementation is common to the first mode of implementation in that one variable wavelength transponder is connected in parallel to a plurality of transponders. In this sense, the first to eighth embodiments set forth above may be applicable for the second mode of implementation of the present invention.

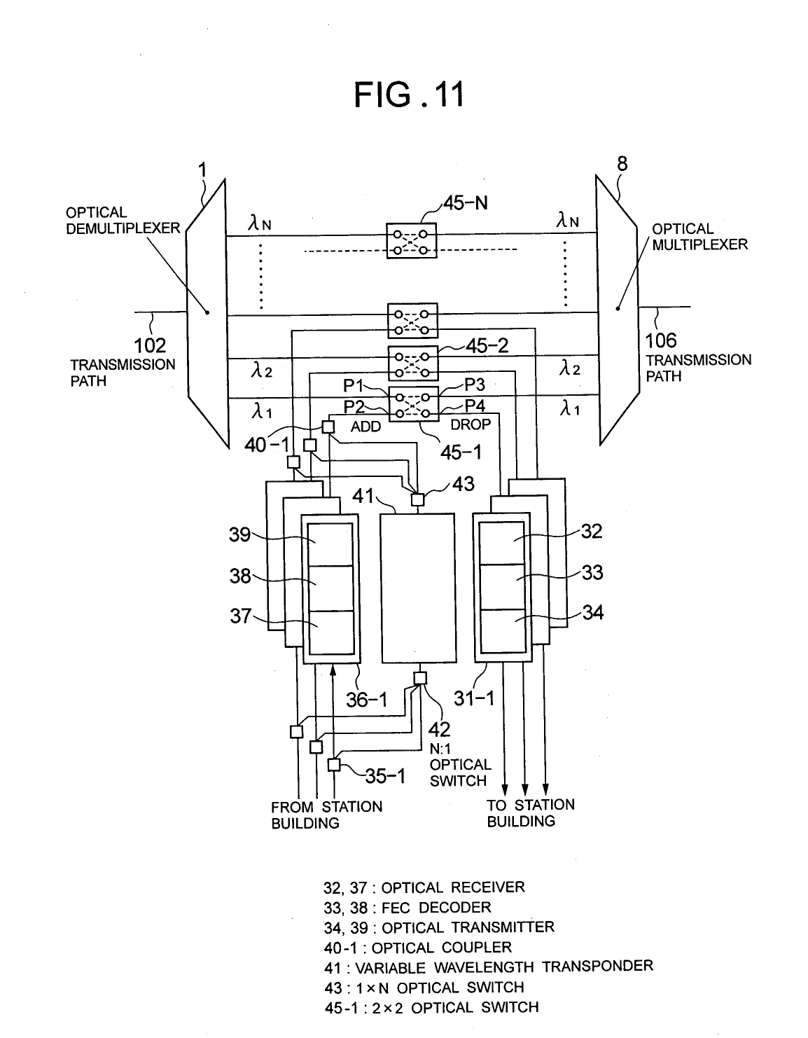

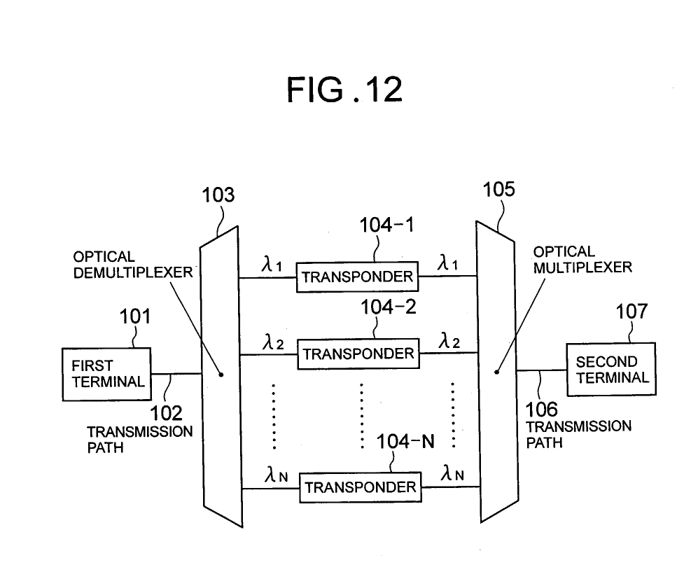

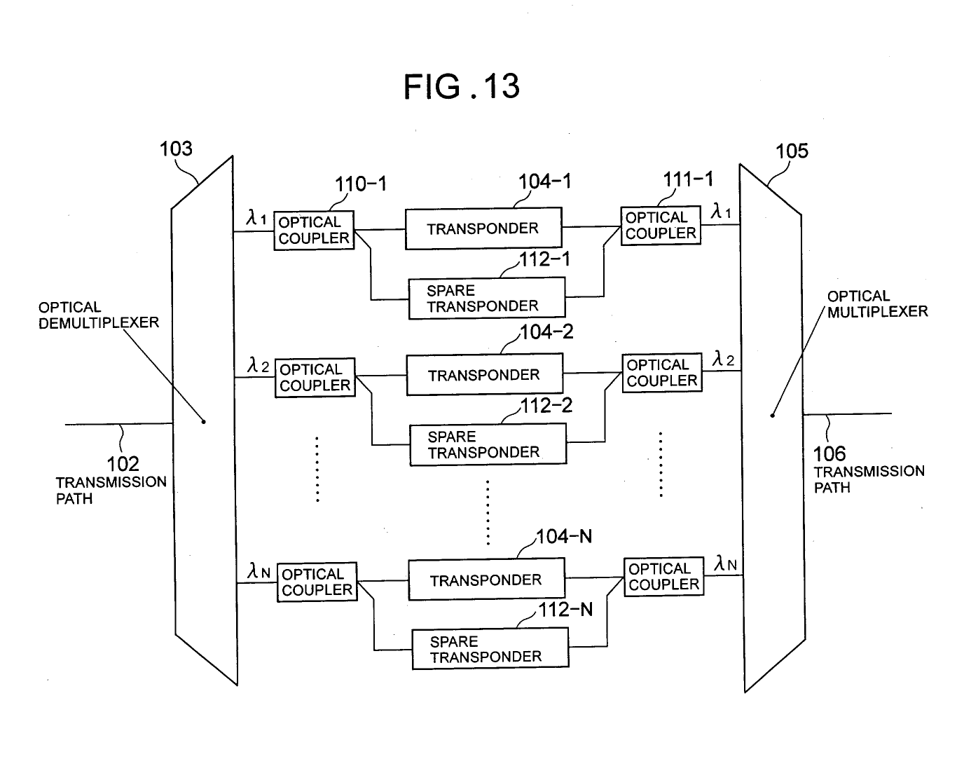

Next, discussion will be given for the ninth embodiment in the second mode of implementation of the present invention. In the second mode of implementation of the invention shown in FIG. 3, discussion has been given for one example, where the present invention is applied to branch (drop) and insert (add) the optical signal branched into respective wavelengths. However, in the ninth embodiment, 2×2 optical switch is employed for branching and insertion. FIG. 11 is a block diagram showing the construction of the ninth embodiment of the present invention. It should be noted that like components in the shown embodiment common to FIG. 3 will be identified by like reference numerals and detailed description of such common components will be eliminated for avoiding redundant disclosure and whereby to keep the disclosure simple enough to facilitate clear understanding of the present invention.

Referring to FIG. 11, the 2×2 optical switches 45-1 to 45-N have two sets of input and output terminals P1 to P4 to receive the optical signal at either a first input terminal P1 or a second input terminal P2 and output the optical signal from either a first output terminal P3 or a second output terminal P4, as controlled by an external control signal. Each 2×2 optical switch 45-1 to 45-N is connected between the optical demultiplexer 1 and the optical multiplexer 8 in series per wavelength.

The first output terminal P3 of each of the 2×2 optical switches 45-1 to 45-N is connected to the optical multiplexer 8 and the second output terminal P4 thereof is connected to the reception transponder 31. On the other hand, the first input terminal P1 of each of the 2×2 optical switches 45-1 to 45-N is connected to the optical demultiplexer 1 and the second input terminal P2 is connected to the transmission transponder 36.

The reception transponder 31 converts the optical signal branched by the optical demultiplexer 1 is converted into the optical signal having wavelength λ a used in the station building and then output to the equipment in the station building. The transmission transponder 36 converts the optical signal processed by the equipment in the station building into the optical signal having the wavelength of the channel to be inserted to output to the second input terminal P2 of the 2×2 optical switch 45-1 to 45-N. The 2×2 optical switches 45-1 to 45-N are controlled to output the optical signal from the transmission transponder 36 to the optical multiplexer 8. Number of the 2×2 optical switches 45-1 to 45-N, the reception transponders 31 and the transmission transponders 36 correspond to number of wavelengths to be branched by the optical demultiplexer 1.

The variable wavelength transponder 41 is arranged in parallel to a plurality of transmission transponders 36-1 to 36-N. Upon occurrence of failure in any one of the transmission transponders 36-1 to 36-N, the variable wavelength transponder 41 takes over the faulty transmission transponder 36-1 to 36-N to transmit the optical signal having wavelength equal to the wavelength of the optical signal to be transmitted to the faulty transmission transponder 36-1 to 46-N, to the 2×2 optical switch 45-1 to 45-N.

Operation will be discussed in terms of the optical signal having wavelength λ1. The optical signal having wavelength λ1 branched by the optical demultiplexer 1 is input to the first input terminal P1 of the 2×2 optical switch 45-1. The 2×2 optical switch 45-1 outputs the optical signal having wavelength λ1 to either the optical multiplexer 8 or the reception transponder 31-1 according to the external control signal.

When the optical signal having wavelength λ1 is processed in the equipment in the not shown station building, the 2×2 optical switch 45-1 controls the optical signal having wavelength λ1 to be output (drop) to the reception side transponder 31-1. When no process is done in the equipment in the station building, the 2×2 optical switch 45-1 controls the optical signal having wavelength λ1 to be output to the optical multiplexer 8. The reception side transponder 31-1 outputs the optical signal having wavelength λ1 to the equipment in the station building after conversion into the optical signal having wavelength λ a to be used in the station building.

On the other hand, the optical signal processed by the equipment in the station building, is converted into the optical signal having wavelength λ1 in the transmission side transponder 36-1 and then is input to the second input terminal P2 of the 2×2 optical switch 45-1. The 2×2 optical switch 45-1 is controlled to output (add) the signal from the transmission side transponder 36-1 to the optical multiplexer 8.

When failure is caused in the transmission side transponder 36-1, the variable wavelength transponder 41 transmits the optical signal having wavelength λ1 to be output by the transmission side transponder 36-1 to the 2×2 optical switch 45-1, in place of the transmission side transponder 36-1.

With the wavelength division multiplexing optical transmission apparatus receiving according to the present invention, includes a plurality of transponders inputting and outputting the branched optical signals of respect wavelength and one or more variable wavelength transponder arranged in parallel to the plurality of transponders. Upon occurrence of failure in any one of the transponders, the optical signal having wavelength equal to that to the faulty transponder is output from the variable wavelength transponder. Therefore, it becomes possible to provide the wavelength division multiplexing optical transmission apparatus economical in operation having high reliability.

On the other hand, the communication system according to the present invention, the effect similar to that achieved by the wavelength division multiplexing optical transmission apparatus set forth above, can be achieved.

Discussing more particularly, in the reproduction relay device for wavelength division multiplexing requires to establish the back-up systems in number corresponding to number of channels in order to smoothly restore upon failure of the transponder, or to stock goods in number corresponding to the number of the channels, or to stock the number of the persons for recovering of the failure. However, employing the present invention, it becomes possible to automatically switch to the reserve transponder upon occurrence of failure of the transponder to establish the optical transmission apparatus with high reliability.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. A wavelength division multiplexing optical transmission apparatus for reproduction relaying of a wavelength division multiplexed optical signal, comprising:
a plurality of transponders inputting and outputting demultiplexed optical signals having respective wavelengths;
at least one variable wavelength transponder arranged in parallel to said plurality of transponders,
on occurring failure in any one of said plurality of transponders, said variable wavelength transponder outputs an optical signal having the wavelength corresponding to the wavelength of the optical signal which should be output from the faulty transponder.

2. A wavelength division multiplexing optical transmission apparatus as set forth in claim 1, which comprises:
monitoring control means responsive to occurrence of failure in any one of said plurality of transponders,
for operating on occurring failure in any one of said plurality of transponders, said variable wavelength transponder outputs an optical signal having the wavelength corresponding to the wavelength of the optical signal which should be output from the faulty transponder.

3. A wavelength division multiplexing optical transmission apparatus as set forth in claim 1, wherein a predetermined number of transponder and said variable wavelength transponder arranged in parallel to said transponders are combined to form one transponder group,
a plurality of transponder groups are provided in parallel,
operations of said predetermined number of transponders and said variable wavelength transponder are monitored per transponder group, and on occurring failure in any one of said plurality of transponders, said variable wavelength transponder outputs an optical signal having the wavelength corresponding to the wavelength of the optical signal which should be output from the faulty transponder.

4. A wavelength division multiplexing optical transmission apparatus as set forth in claim 1, which further comprises:
an optical demultiplexing means for demultiplexing the wavelength division multiplexed optical signal into respective wavelengths of optical signals;
a plurality of first optical couplers branching demultiplexed respective wavelengths of optical signals for inputting one of branched optical signals of respective wavelengths to respective of said transponders;
a first optical switch selecting a particular optical signal among the other of the optical signals branched by said plurality of optical couplers for inputting to said variable wavelength transponder;
a second optical switch selecting outputting destination of an output signal from said variable wavelength transponder;
a plurality of second optical couplers coupling the output signals of said respective transponders and the output signal from said second optical switch; and
optical multiplexing means for multiplexing output signals from said plurality of second optical couplers,
when failure is caused in any of said plurality of transponders, said monitoring control means controls said first optical switch, the faulty transponder, said variable wavelength transponder and said second optical switch for transmitting the optical signal having wavelength equal to that of the optical signal to be transmitted from said faulty transponder, from said variable wavelength transponder to said optical multiplexing means.

5. A wavelength division multiplexing optical transmission apparatus as set forth in claim 1, wherein said plurality of transponders is constructed with a plurality of first transponders connected input ends to said optical demultiplexing means and output ends to an equipment in a station building, and a plurality of second transponders taking optical signals of respective wavelengths from said equipment in the station building as input signals and outputting to said optical multiplexing means,
said variable wavelength transponder is arranged in parallel to said plurality of second transponders.

6. A wavelength division multiplexing optical transmission apparatus as set forth in claim 1, which further comprises:
a plurality of optical switches connected between said optical demultiplexing means and said optical multiplexing means per wavelength, a plurality of first transponders providing corresponding to respective optical switches, a plurality of second transponders providing corresponding to respective optical switches, and said variable wavelength transponder,
each of said optical switches has a function for selecting one of the optical signal from said first transponder and the optical signal from said optical demultiplexing means to feed to said optical multiplexing means, and a function for transmitting the optical signal from said optical demultiplexing means to one of said second transponder and said optical multiplexing means, and
said variable wavelength transponder is arranged in parallel to said plurality of first transponders.

7. A wavelength division multiplexing optical transmission apparatus as set forth in claim 2, wherein said monitoring control means is responsive to detection of occurrence of failure in any transponder among said plurality of transponders for interrupting optical output of said faulty transponder and subsequently transmitting the optical signal having wavelength equal to that of the optical signal to be transmitted by said faulty transponder from said variable wavelength transponder to said optical multiplexing means.

8. A wavelength division multiplexing optical transmission apparatus as set forth in claim 4, which further comprises a third optical switch provided in place of said first optical coupler, and
when failure is caused in any of said plurality of transponders, said monitoring control means controls said third optical switch, said first optical switch, the faulty transponder, said variable wavelength transponder and said second optical switch for transmitting the optical signal having wavelength equal to that of the optical signal to be transmitted from said faulty transponder, from said variable wavelength transponder to said optical multiplexing means.

9. A wavelength division multiplexing optical transmission apparatus as set forth in claim 4, which further comprises a third optical switch provided in place of said first optical coupler, and a third optical coupler provided in place of said first optical switch, and
when failure is caused in any of said plurality of transponders, said monitoring control means controls said third optical switch, the faulty transponder, said variable wavelength transponder and said second optical switch for transmitting the optical signal having wavelength equal to that of the optical signal to be transmitted from said faulty transponder, from said variable wavelength transponder to said optical multiplexing means.

10. A wavelength division multiplexing optical transmission apparatus as set forth in claim 4, which further comprises a fourth optical switch provided in place of said second optical coupler, and
when failure is caused in any of said plurality of transponders, said monitoring control means controls the faulty transponder, said variable wavelength transponder, said second optical switch and said fourth optical switch for transmitting the optical signal having wavelength equal to that of the optical signal to be transmitted from said faulty transponder, from said variable wavelength transponder to said optical multiplexing means.

11. A wavelength division multiplexing optical transmission apparatus as set forth in claim 4, wherein said optical multiplexing means includes an optical power monitor for monitoring output of the input optical signal, and
when an optical output of said transponder going out of standard is detected as a result of monitoring by said optical power monitor, said monitoring control means transmits the optical signal having wavelength equal to that of the optical signal to be transmitted from said faulty transponder, from said variable wavelength transponder to said optical multiplexing means.

12. A wavelength division multiplexing optical transmission apparatus as set forth in claim 4, wherein an optical transmitter of said transponder includes an optical power monitor for monitoring output of the optical signal to be transmitted, and when an optical output of said transponder going out of standard is detected as a result of monitoring by said optical power monitor, said monitoring control means transmits the optical signal having wavelength equal to that of the optical signal to be transmitted from said faulty transponder, from said variable wavelength transponder to said optical multiplexing means.

13. A wavelength division multiplexing optical transmission apparatus as set forth in claim 1, wherein said transponder includes a function of error correction of the optical signal converted into an electric signal.

14. A wavelength division multiplexing optical transmission apparatus as set forth in claim 2, wherein said transponder includes a signal quality monitoring function of the optical signal converted into an electric signal, and
said monitoring control means is responsive to an alarm indicative a signal quality of the optical signal converted into the electric signal going out of standard, transmits the optical signal having wavelength equal to that of the optical signal to be transmitted from said faulty transponder, from said variable wavelength transponder to said optical multiplexing means.

15. A wavelength division multiplexing optical transmission apparatus as set forth in claim 4, wherein a branching ratio of said first optical coupler is not equal and an optical amplifier is connected between said first optical switch and said variable wavelength transponder in series, and
when failure is caused in any of said plurality of transponders, said monitoring control means controls said first optical switch, the faulty transponder, said variable wavelength transponder and said second optical switch for transmitting the optical signal having wavelength equal to that of the optical signal to be transmitted from said faulty transponder, from said variable wavelength transponder to said optical multiplexing means.

16. A communication system including at least one wavelength division multiplexing optical transmission apparatus set forth in claim 1 between a first terminal and a second terminal terminating the wavelength division multiplexed optical signal.
